(19) United States
(12) Patent Application Publication
(10) Pub. No.: US 2020/0378750 A1
(43) Pub. Date: Dec. 3, 2020

(54) OVERHEAD WIRE MUTUAL SEPARATING SITUATION MEASURING APPARATUS AND OVERHEAD WIRE MUTUAL SEPARATING SITUATION MEASURING METHOD

(71) Applicant: HITACHI HIGH-TECH FINE SYSTEMS CORPORATION, Saitama (JP)

(72) Inventors: Masahisa WATANABE, Saitama (JP); Masaki ARAKI, Saitama (JP); Shusaku UTSUGI, Saitama (JP); Toshio EIFUKU, Saitama (JP)

(73) Assignee: HITACHI HIGH-TECH FINE SYSTEMS CORPORATION, Saitama (JP)

(21) Appl. No.: 16/886,739

(22) Filed: May 28, 2020

(30) Foreign Application Priority Data
May 29, 2019 (JP) 2019-100503

(51) Int. Cl. G01B 11/14; B60L 9/00; B60M 1/12

(52) U.S. Cl. CPC G01B 11/14; B60M 1/12; B60L 9/00

(57) ABSTRACT

An overhead wire mutual separating situation measuring apparatus detects separation of overhead wires with high accuracy in a manner that the overhead wires are placed with a predetermined amount of deviation. A light projecting unit irradiates overhead wires above a railway with a measuring light spreading in a strip shape in the width direction of the railway. Light receiving units receive light reflected by all or a portion of the overhead wires from the measuring light to output a measurement signal indicative of a contour of the overhead wires. Each light receiving unit mutually partially overlaps a measurement area such that the overhead wires within a predetermined measurement area fall within the measurement visual area of at least one light receiving unit. The processing device processes the measurement signal from each light receiving unit to detect a mutual separation of the overhead wires and the positional deviation thereof.

### FIELD OF THE INVENTION

The present invention relates to a measuring apparatus and a measuring method for measuring an overhead wire, i.e., trolley wire, that supplies electric power to vehicles such as a railway, and particularly to an overhead wire mutual separating situation measuring apparatus and overhead wire mutual separating situation measuring method suitable for measuring the difference in height, hereinafter referred to as “mutual separating situation”, among/between a plurality of overhead wires which are installed close to each other.

### BACKGROUND OF THE INVENTION

The overhead wire installed above the track of the railway contacts the railing plate of the hull mounted on the roof of the railway vehicle by a pantograph to supply electric power to the vehicle. Because the length of overhead wire has been limited by manufacturing process, the end of the installed overhead wire is installed with, for the sake of keeping power supplying to the vehicle uninterrupted, an overhead wire which starts supplying power to a newly added vehicle in addition to an overhead wire which is supplying power to the present vehicle in such a manner that the overhead wire supplying power to a newly added vehicle is installed side by side to the overhead wire supplying power to the present vehicle. In addition, in the area above the branch point of the railway, the overhead wire of the main rail and the overhead wire of the crossover rail are installed in an intersecting way such that there is a risk that the overhead wire would be damaged in a position where a plurality of overhead wires are multiplied installed when the overhead wire passes under the horn of the boat body to catch the pantograph if the height of the overhead wire which starts supplying power to the newly added vehicle is lower than a specific value. Therefore, it is necessary to measure and manage the height of the overhead wire. Conventionally, in Patent Document 1, it has disclosed a technique that easily measures the height of an insulator which supports an overhead wire at an air section, i.e., a connecting portion between the overhead wire and the overhead wire.

### PRIOR ART DOCUMENTS

Patent Document 1: JP-A-2001-21321

### SUMMARY OF THE INVENTION

An overhead wire is installed in a zigzag manner in width direction of railway in order to prevent from local abrasion of the sliding plate of the boat body mounted on the pantograph. In order to prevent the overhead wire from passing under the horn of the boat body and catching the pantograph, the overhead wire should be in a position with positional deviation within a predetermined amount (e.g., 900 mm) from the horns at both ends of the boat body in a visual view from the center position of the railway width, and therefore it is necessary to control the height of the overhead wire. Accordingly it is appropriate to determine whether a plurality of overhead wires is in the mutual separating situation based on whether the height of the overhead wire is in a good condition or not. However, in Patent Document 1, it does not consider the mutual separating situation for the plurality of overhead wires. Furthermore, when the technique described in Patent Document 1 is used to detect the mutual separating situation of the plurality of overhead wires, there will be a problem that a large amount of imaging apparatus, i.e., cameras, and a large amount of corresponding image processing apparatus are required. In addition, there is a problem that it is difficult to process the image inside an inspecting vehicle while the inspecting vehicle is running in consideration of the issue that the amount of image to be processing is enormous.

An object of the present invention is to provide a small and simple structure which could detect the mutual separating situation of a plurality of overhead wires with high accuracy in a manner that the overhead wires is placed with a predetermined amount of deviation.

The measuring apparatus of present invention measures mutual separating situation of overhead wires, comprising a light projecting unit provided on a railway vehicle running on a railway, the light projecting unit projecting a measuring light, which spreads in a strip shape in a width direction of the railway, toward a plurality of overhead wires installed above the railway; a plurality of light receiving units provided on the railway vehicle in a manner that each light receiving unit is separate to each other in the width direction of the railway, the plurality of light receiving units respectively receiving a reflecting light which is reflected by all or a portion of the plurality of overhead wires from the measure light so as to output a measurement signal indicative of a contour of overhead wires; and a processing device which processes the measurement signal outputted from the plurality of light receiving units, wherein each light receiving unit is disposed to mutually partially overlap a measurement area to each other in a manner that all of the plurality of overhead wires within a predetermined measurement area are fallen within the measurement area of at least one of the light receiving units, and the processing device processes the measurement signal outputted from each light receiving unit according to installing position of each light receiving units to detect a mutual separating situation of the plurality of overhead wires and a positional deviation of each overhead wire.

The measuring method of present invention measures mutual separating situation of overhead wires, comprising the following steps of projecting, from a light projecting unit provided on a railway vehicle running on a railway, a measuring light spreads in a strip shape in a width direction of the railway toward a plurality of overhead wires installed above the railway; providing a plurality of light receiving units on the railway vehicle in a manner that each light receiving unit is separate to each other in the width direction of the railway, wherein each of the light receiving units is disposed to partially overlap a measurement area of each other such that all of the plurality of overhead wires within a predetermined measurement area fall within the measurement area of at least one of the light receiving units; respectively receiving, by the plurality of light receiving units, a reflecting light which is reflected by all or a portion of the plurality of overhead wires from the measure light so as to output a measurement signal indicative of a contour of overhead wires; and processing the measurement signal outputted from each light receiving unit according to installing position of each light receiving units to detect a mutual separating situation of the plurality of overhead wires and a positional deviation of each overhead wire.

A plurality of light receiving units are provided on the railway vehicle in a manner that each light receiving unit is separate to each other in the width direction of the railway, the plurality of light receiving units respectively receive the reflecting light which is reflected by all or a part of the plurality of overhead wires, outputs a measurement signal indicating the contour of each overhead wire and processes the measurement signals outputted by the plurality of light receiving units according to installing position of each light receiving units to detect a mutual separating situation of the plurality of overhead wires and a positional deviation of each overhead wire, therefore the mutual separating situation of the plurality of overhead wires is detected with high accuracy at a position where any of the overhead wires is displaced by a predetermined amount. Because each of the light receiving units is disposed to partially overlap a measurement area of each other such that all of the plurality of overhead wires within a predetermined measurement area fall within the measurement area of at least one of the light receiving units, it is not necessary for a overhead wires that detect mutual separating situation to be within the range of the measurement area of the same light receiving unit, the number of light receiving units can be reduced and the processing amount of the measurement signal can be reduced to accordingly achieve a smaller and simpler structure. If a light receiving unit having a wide measurement area is used, the number of light receiving units can be further reduced and the processing amount of the measurement signal can be further reduced to accordingly achieve a further smaller and simpler structure.

Furthermore, in the measuring apparatus of the present invention, the processing device processes the measurement signal outputted from each receiving unit to detect a mutual separating situation between one of the plurality of overhead wires and an insulator which supports another overhead wire.

Furthermore, the measuring method of the present invention further comprising a step of processing the measurement signal outputted from each receiving unit to detect a mutual separating situation between one of the plurality of overhead wires and an insulator which supports another overhead wire.

Since the measurement signals outputted by the plurality of light receiving units are processed to detect the mutual separating situation between one of the pluralities of overhead wires and the insulator supporting the other overhead wire, the height of the insulator supporting the overhead wire can be controlled.

Further, in the measuring apparatus of the present invention, the processing device corrects the measurement signal outputted from each light receiving unit according to the information indicating the nonlinear characteristic of the measurement signal regarding each light receiving unit such that the corrected measurement signal is used to detect the mutual separating situation between/among the plurality of overhead wires and the positional deviation of each overhead wire.

Further, the measuring method of the present invention further comprising a step of correcting the measurement signal outputted from the light receiving unit according to information indicative of a nonlinear characteristic of the measurement signal regarding each light receiving unit such that the corrected measurement signal is used to detect the mutual separating situation between/among the plurality of overhead wires and the positional deviation of each overhead wire.

When the measuring field of the light receiving unit is wide, the nonlinearity of the measurement signal in the corners of the measurement area becomes larger than that in the vicinity of the central part of the measurement area. The measurement signal outputted by each light receiving unit is corrected according to the information indicating the nonlinearity characteristics of the measurement signal for each light receiving unit, and the corrected measurement signal is used to detect the mutual separating situation between/among the plurality of overhead wires and the positional deviation of each overhead wire, and therefore the mutual separating situation between/among the plurality of overhead wires and the positional deviation of each overhead wire can be measured with higher accuracy.

According to the present invention, it is possible to provide a small and simple structure which could detect the mutual separating situation of a plurality of overhead wires with high accuracy in a manner that the overhead wires is placed with a predetermined amount of deviation structure.

Furthermore, the present invention processes the measurement signals outputted by the plurality of light receiving units and detects the mutual separating situation between one of the pluralities of overhead wires and the insulator supporting another overhead wire such that the height of the insulator supporting the overhead wire becomes manageable.

Furthermore, the measurement signal outputted by each light receiving unit is corrected according to the information indicating the nonlinearity characteristics of the measurement signal for each light receiving unit, the corrected measurement signal is used to detect the mutual separating situation between/among the plurality of overhead wires and the positional deviation of each overhead wire such that the mutual separating situation between/among the plurality of overhead wires and the positional deviation of each overhead wire can be measured with higher accuracy.

### BRIEF DESCRIPTION OF THE DRAWINGS

FIG. 1 is a diagram illustrating a schematic structure of a measuring apparatus according to one embodiment of the present invention.

FIG. 2A is a perspective view of an overhead wire at an overlapping point of overhead wires.

FIG. 2B is a top view of the overhead wire at an overlapping point of overhead wires.

FIG. 3A is a diagram illustrating a structural example of a light projecting unit and a light receiving unit.

FIG. 3B is a diagram illustrating internal equipment of the light projecting unit.

FIG. 4 is a flow chart illustrating mutual overhead wire separation measurement process of the embodiment.

FIG. 5 is a figure explaining the mutual separating situation and the positional deviation of overhead wires.

FIGS. 6A and 6B are figures explaining the mutual separating situation of an overhead wire and an insulator.

### DETAILED DESCRIPTION OF THE PREFERRED EMBODIMENTS

(Structure of Measuring Apparatus that Measures Mutual Separating Situation of Overhead Wires)

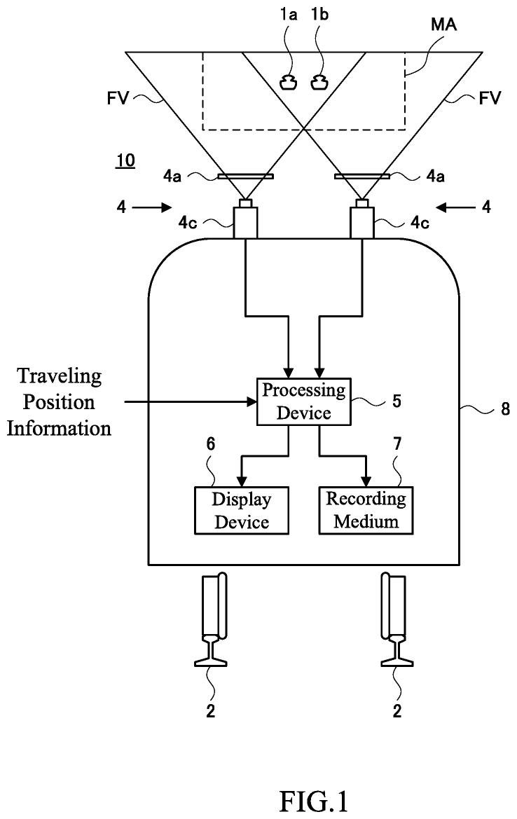

FIG. 1 is a diagram illustrating a schematic structure of a measuring apparatus that measures mutual separating situation of overhead wires according to one embodiment of the present invention. The overhead wire mutual separating situation measuring apparatus 10 includes a light projecting unit, not shown, a plurality of light receiving units 4, a processing device 5, a display device 6, and a recording medium 7. The overhead wire mutual separating situation measuring apparatus 10 is mounted on an overhead wire inspecting vehicle 8 traveling on the railway 2. A plurality of overhead wires 1a and 1b, i.e., trolley wires, are installed in an overlapping manner above the railway 2 on which the overhead wire inspecting vehicle travels.

In addition, the processing device 5 of the overhead wire mutual separating situation measuring apparatus 10 described in the below embodiment performs the overhead wire mutual separating situation measurement process within the overhead wire inspecting vehicle 8, but the present invention does not limit to this. Other embodiment that uses a processing device providing on the ground outside the overhead wire inspecting vehicle 8 to perform all or part of the processing could also be applied.

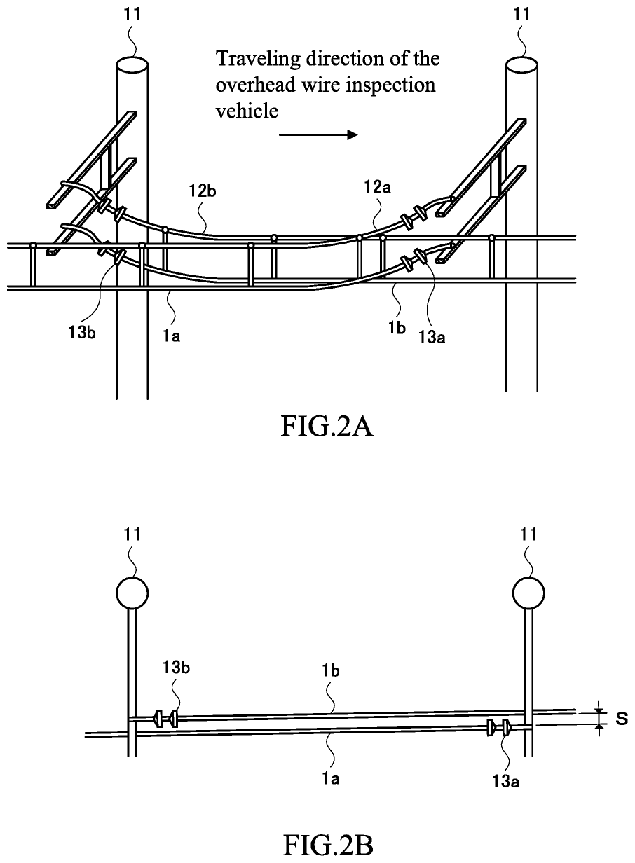

FIG. 2A is a perspective view of an overhead wire at an overlapping point of the overhead wire, and FIG. 2B is a top view of the overhead wire at an overlapping point of the overhead wire. In FIG. 2A, when the traveling direction of the overhead wire inspecting vehicle is indicated by an arrow, the overhead wire 1a is provided between the two support columns 11 by the hanger wire 12a and the insulator 13a at the end of the overhead wire 1a that supplies power to the overhead wire inspecting vehicle. In addition, an overhead wire 1b that starts supplying power to the overhead wire inspecting vehicle is provided between the two support columns 11 by the hanger wire 12b and the insulator 13b. Therefore, the two overhead wires 1a and 1b are provided in an overlapping manner between the two support columns 11. As a result, electric power is supplied to the overhead wire inspecting vehicle running between the two support columns 11 without interruption.

In FIG. 2A, the mutual separating situation between the two overhead wires 1a and 1b varies depending on the height of each overhead wire 1a and 1b. Further, in FIG. 2B, when viewed from above, in order to install the overhead wires 1a and 1b in deviation positions in the railway width direction, the spacing S between the two overhead wires 1a and 1b varies depending on the positional deviation of each overhead wire 1a and 1b.

In FIG. 1, the overhead wire mutual separating situation measuring apparatus 10 according to the present embodiment comprises a plurality of light receiving units 4, and each light receiving unit 4 is separated on the roof of the overhead wire inspecting vehicle 8 in the width direction of the railway 2. A light projecting unit, not shown, is also provided on the roof of the overhead wire inspecting vehicle 8. A processing device 5, a display device 6, and a recording medium 7 are mounted inside the overhead wire inspecting vehicle 8.

In addition, in the longitudinal direction, i.e., traveling direction, of the overhead wire inspecting vehicle 8, two sets of a light projecting unit and a light receiving unit, which will be described below, are provided in front of and behind the pantograph of the roof of the overhead wire inspecting vehicle 8 with the pantograph sandwiched therebetween. Since the height of the overhead wire changes by an upward pushing amount by the pantograph, the measurement is performed at a position where the pantograph does not push upward according to the traveling direction of the overhead wire inspecting vehicle 8.

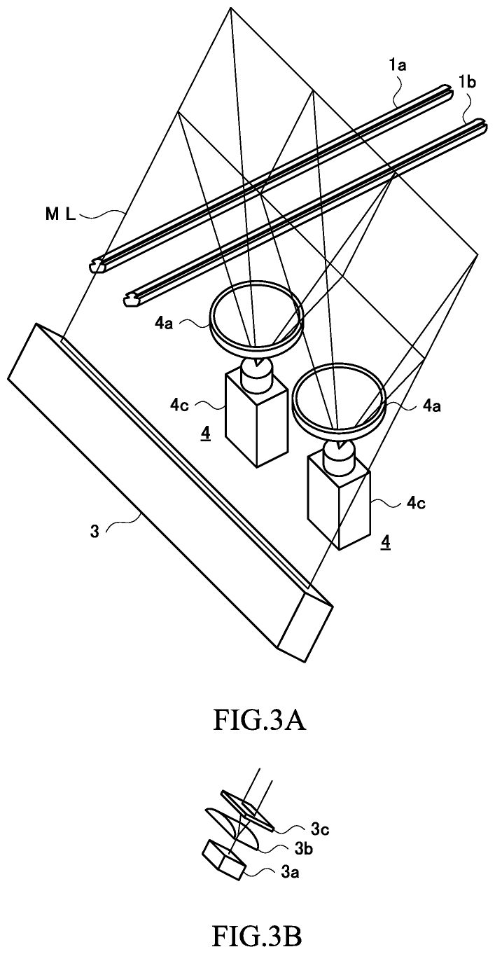

FIG. 3A is a diagram illustrating a structural example of a light projecting unit and a light receiving unit, and FIG. 3B is a diagram illustrating internal equipment of the light projecting unit. In FIG. 3B, the internal equipment of the light projecting unit comprises a laser light source 3a, a light projecting lens 3b, and a slit 3c. The laser light source 3a comprise, for example, a laser diode or the like, and emits monochromatic laser light in the infrared region. The wavelength of the laser light is, for example, 850 nm. The light projecting lens 3b comprises, for example, a cylindrical lens or the like, and spreads the laser light generated from the laser light source 3a in the railway width direction. The laser light that has passed through the light projecting lens 3b passes through the slit 3c and becomes laser light that spreads in a band shape. In FIG. 3A, the light projecting unit 3 has a plurality of sets of the internal equipment shown in FIG. 3B in the railway width direction, and irradiates a measurement light ML which spreads in a strip shape in the rail width direction toward the overhead wires 1a and 1b.

The light receiving units 4 are each configured to comprise an interference filter 4a and a camera 4c. The reflected light which is the measurement light ML reflected by the overhead wires 1a and 1b is transmitted through the interference filter 4a and then received by the camera 4c. The interference filter 4a limits the wavelength of the transmitting light to the wavelength of the measurement light ML. The camera 4c comprises, for example, a 3D (three-dimensional) camera having a light receiving element such as a CMOS sensor, and outputs a measurement signal corresponding to the intensity of the received light. These measurement signals are binarized image signals and are provided to indicate the contours (position and height of the surface) of each overhead wire 1a, 1b. When it is necessary to remove the sunlight included in the transmitted light of the interference filter 4a, a polarizing plate could be provided between the interference filter 4a and the camera 4c.

In addition, in the structural example shown in FIG. 3A, the measurement light ML from the light projecting unit 3 to the overhead wires 1a and 1b is emitted at a slight inclination in relation to the perpendicular upward direction. In another embodiment, the measurement light ML could emit toward the perpendicular upward direction, and the light receiving unit 4 could be installed inclined in relation to the perpendicular upward direction. Further, both the light projecting unit 3 and the light receiving unit 4 could be provided so as to be inclined in relation to the perpendicular upward direction.

In FIG. 1, reference numeral FV indicates the range of the measurement visual area of each light receiving unit 4. Further, symbol MA indicates a predetermined measurement area. In FIG. 1, each light receiving units 4 is installed to enable the measurement visual area FVs to mutual partially overlapped in such a manner that all of the plurality of overhead wires 1a and 1b in the measurement area MA indicated by a broken line are fallen within the measurement visual area FV of at least one light receiving unit 4. It is not necessary to have the plurality of overhead wires 1a and 1b for detecting mutual separating situation to be within the range of the measurement area of the same light receiving unit 4. Thus the number of light receiving units 4 can be reduced and the processing task for the measurement signal can be reduced to accordingly achieve a smaller and simpler structure. When the light receiving unit 4 having a wide measurement area is used, the number of the light receiving units 4 can be further reduced and the processing tasks for the measurement signal can be further reduced to accordingly achieve a further smaller and simpler structure. In the present embodiment, the light receiving units 4 having a wide measurement area are used, and the number of the light receiving units 4 in the railway width direction is set to a minimum of two.

Note that, for example, if a light receiving unit having a measurement area 1.5 times wider is used and one light receiving unit in the railway width direction is provided, the dimension of the measurement area MA in the height direction becomes extremely small. At least two light receiving units 4 are provided in the railway width direction in present invention.

The processing apparatus 5 comprises, for example, a personal computer in which a CPU, i.e., central processing unit, a memory, an HDD, i.e., hard disc drive, and a DIO, i.e., digital input-output interface, are connected by buses. The HDD of the processing device 5 stores a template showing a reference profile of an overhead wire and an insulator, and a coordinate conversion table is generated based on information of the installation position of each light receiving unit 4. This coordinate conversion table shows the correspondence relationship of the XY coordinates on a binarized image signal which is a measurement signal of each light receiving unit 4 and X′Y′ coordinates having an origin at a predetermined reference point on the overhead wire inspecting vehicle 8.

When the measurement area of the light receiving unit 4 is wide, the nonlinearity of the measurement signal becomes larger in the corners of the measurement area than in the vicinity of the central part of the measurement area. The HDD of the processing device 5 stores information indicating the non-linear characteristic of the measurement signal for each light receiving unit 4. These information are information indicating how much nonlinearity of the measurement signal occurs and which position it occurs within the range of the measurement area, and these information could be previously obtained from, for example, an image data which is acquired by photographing a square-patterned object by each light receiving unit 4, etc.

The processing device 5 performs the processing described below, detects the mutual separating situation between the plurality of overhead wires 1a, 1b, or the mutual separating situation between one overhead wire and the insulator supporting the other overhead wire, and detects the positional deviation of each overhead wire 1a, 1b from the measurement signals outputted from the plurality of light receiving units 4 according to the information on the installation position of each light receiving unit 4. The traveling position information of the vehicle is input to the processing device 5, the measurement data is synchronized with the traveling position of the vehicle, and the traveling position information of the vehicle is added to the measurement data. The display device 6 comprises, for example, a flat panel display or the like, and displays the detection result of the processing device 5 under the control of the processing device 5. The recording medium 7 is, for example, an SSD, i.e., solid state drive, and records the measurement data under the control of the processing device 5.

(Measurement Process for the Mutual Separating Situation of Overhead Wires)

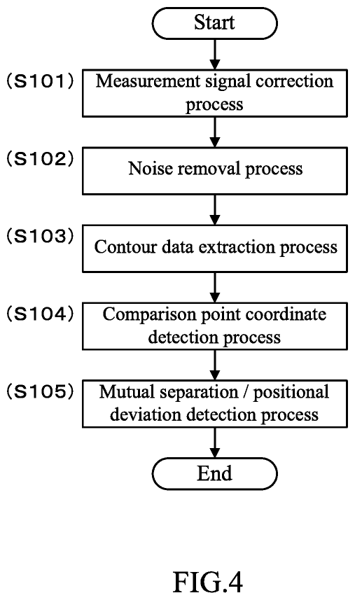

FIG. 4 is a flowchart illustrating an overhead wire mutual separating situation measurement process according to the present embodiment. In the measurement signal correction process in step 101, the processing device 5 corrects the measurement signal outputted by each light receiving unit 4 according to the information indicating the nonlinear characteristic of the measurement signal for each light receiving unit 4 stored in the HDD. As a result it improves the processing accuracy in the subsequent processing.

In the noise removal process of step 102, the processing device 5 performs noise removal process on the binarized image signal which is the measurement signal of each light receiving unit 4 to remove isolated points from the binarized image signal.

In the contour data extraction process in step 103, the processing device 5 uses the template indicating the reference profile of the overhead wire or the insulator stored in the HDD to extract the data which indicates the contour of each overhead wire 1a, 1b or the insulator from the binarized image signal. At this time, for each of the overhead wires 1a and 1b, data indicating the contour including the worn portion of the overhead wires 1a and 1b is extracted by pattern matching with the image of the side surface of the overhead wire and the template.

In the comparison point coordinate detection process of step 104, the processing device 5 detects the XY coordinates on the binarized image signal of each comparison point which will described below from the extracted data indicating the contours of the overhead wires 1a and 1b or the insulators. Then the processing device 5 uses the coordinate conversion table stored in the HDD to convert the XY coordinates of each detected comparison point into the predetermined reference X′Y′ coordinates as the original point.

In the mutual separating situation/positional deviation detection process in step 105, the processing device 5 detects the mutual separating situation of the plurality of overhead wires 1a and 1b, the mutual separating situation of one overhead wire and the insulator that supports the wire other overhead wire, and the positional deviation of each overhead wire 1a, 1b.

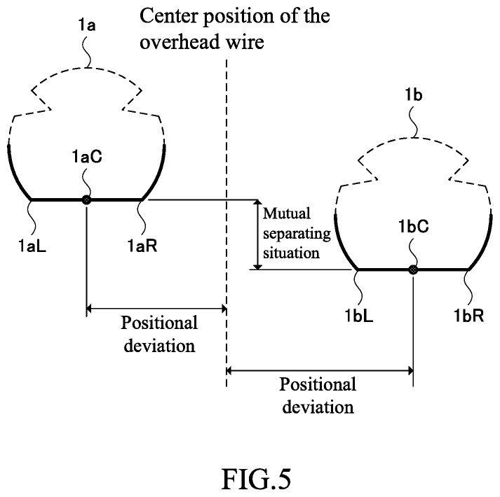

FIG. 5 is a diagram illustrating the mutual separating situation and the positional deviation of overhead wires. It is assumed that the contour data extraction process in step 103 of FIG. 4 extracts, for each overhead wire 1a and 1b, data indicating the contour of the portion shown by the solid line below the overhead wires 1a and 1b. In the data indicating the contour of the overhead wire 1a, the left end of the worn bottom surface is determined as the point 1aL, the right end is determined as the point 1aR, and the intermediate position between them is determined as the comparison point 1aC. In similarity, in the data indicating the contour of the overhead wire 1b, the left end of the worn bottom surface is determined as the point 1bL, the right end is determined as the point 1bR, and the intermediate position between them is determined as the comparison point 1bC.

In the comparison point coordinate detection process of step 104 of FIG. 4, the processing device 5 first detects the XY coordinates of the comparison points 1aC and 1bC on the binarized image signal. Then, the processing device 5 uses the coordinate conversion table to convert the detected XY coordinates of the comparison points 1aC and 1bC into predetermined reference X′Y′ coordinates as the original point.

In the mutual separating situation/positional deviation detection process of step 105 of FIG. 4, the processing device 5 detects the difference between the coordinate (Y′ coordinate) in the height direction of the comparison point 1aC and the coordinate (Y′ coordinate) in the height direction of the comparison point 1Bc, and takes the difference as a mutual separating situation of the overhead wires 1a and 1b. Further, the processing device 5 detects the difference between the coordinate, i.e., X′ coordinate, of the comparison point 1aC in the railway width direction and the coordinate of the center position of the overhead wire inspecting vehicle, and takes the difference as the positional deviation of the overhead wire 1a. Similarly, the processing device 5 detects the difference between the coordinate, i.e., X′ coordinate, of the comparison point 1bC in the railway width direction and the coordinate of the center position of the overhead wire inspecting vehicle, and takes the difference as the positional deviation of the overhead wire 1b.

In addition, if the original point, i.e., reference point, of the X′Y′ coordinates is set on the center line of the overhead wire inspecting vehicle, the X′ coordinates after the coordinate conversion of each comparison point 1aC, 1bC will be the same as detected as a positional deviation of each overhead wire 1a, 1b.

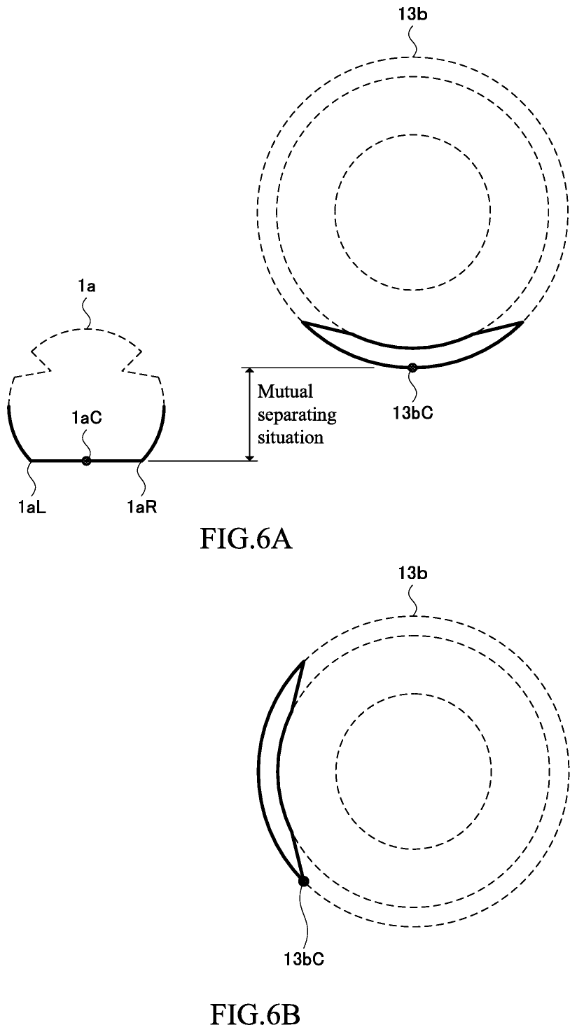

FIGS. 6A and 6B are diagrams for explaining the mutual separating situation between the overhead wire and the insulator. In FIGS. 6A and 6B, for the insulator 13b indicated by the broken line, the data indicating the contour of the insulator extracted in step 103 of FIG. 4 indicates the contour of a part of the insulator as indicated by the solid line. As illustrated in FIG. 6A, when the data indicating the outline of the lower part of the insulator is extracted, the lowest point of them is determined as the comparison point 13bC. Then, the processing device 5 detects the difference between the coordinate, i.e., Y′ coordinate, in the height direction of the comparison point 1aC and the coordinate, i.e., Y′ coordinate, in the height direction of the comparison point 13bC as the mutual separating situation between the overhead wire 1a and the insulator 13b. Further, as illustrated in FIG. 6B, when the data indicating the contour of the lateral portion of the insulator is extracted, the lowest point of them is determined as the comparison point 13bC. Then, the processing device 5 detects the difference between the coordinate, i.e., Y′ coordinate, in the height direction of the comparison point 1aC and the coordinate, i.e., Y′ coordinate, in the height direction of the comparison point 13bC as the mutual separating situation between the overhead wire 1a and the insulator 13b.

According to the embodiment described above, the following effects of the present invention are obtained.

(1) With a small and a simple structure, the mutual separating situation of the plurality of overhead wires 1a and 1b can be detected with high accuracy in a manner that the overhead wires is placed by a predetermined amount of deviation.
(2) Further, the plurality of light receiving units 4 could process the outputted measurement signals outputted to detect the mutual separating situation between one of the plurality of overhead wires 1a and 1b and the insulator supporting the other overhead wire, and thus the height of the insulator which supporting the overhead wire can be managed.
(3) Furthermore, the measurement signal outputted by each light receiving unit 4 is corrected according to the information indicating the nonlinear characteristic of the measurement signal for each light receiving unit 4, and the mutual separating situation of the plurality of overhead wires 1a, 1b and the positional deviation of each overhead wire 1a, 1b can be detected with higher accuracy by using of corrected measurement signal.

In the embodiment described above, two light receiving units 4 are provided in the railway width direction, but three or more light receiving units could be provided in the railway width direction. Further, although the 3D camera is used in the light receiving unit 4, the light receiving device of the light receiving unit does not limit to this and could be a two-dimensional displacement sensor or the like. Furthermore, in the embodiment described above, a monochromatic laser light in the infrared region is used as the measurement light, but the measurement light does not limit to the infrared laser light as long as it produces reflected light stronger than the light intensity of sunlight in the daytime from the overhead wire.

What is claimed is:

1. A measuring apparatus that measures mutual separating situation of overhead wires, comprising:
a light projecting unit provided on a railway vehicle running on a railway, the light projecting unit projecting a measuring light, which spreads in a strip shape in a width direction of the railway, toward a plurality of overhead wires installed above the railway;
a plurality of light receiving units provided on the railway vehicle in a manner that each light receiving unit is separate to each other in the width direction of the railway, the plurality of light receiving units respectively receiving a reflecting light which is reflected by all or a portion of the plurality of overhead wires from the measure light so as to output a measurement signal indicative of a contour of overhead wires; and
a processing device which processes the measurement signal outputted from the plurality of light receiving units, wherein:
each light receiving unit is disposed to mutually partially overlap a measurement area to each other in a manner that all of the plurality of overhead wires within a predetermined measurement area are fallen within the measurement area of at least one of the light receiving units, and
the processing device processes the measurement signal outputted from each light receiving unit according to installing position of each light receiving units to detect a mutual separating situation of the plurality of overhead wires and a positional deviation of each overhead wire.

2. The measuring apparatus as claimed in claim 1, wherein the processing device processes the measurement signal outputted from each receiving unit to detect a mutual separating situation between one of the plurality of overhead wires and an insulator which supports another overhead wire.

3. The measuring apparatus as claimed in claim 1, wherein the processing apparatus corrects the measurement signal outputted from the light receiving unit according to information indicative of a nonlinear characteristic of the measurement signal regarding each light receiving unit such that the corrected measurement signal is used to detect the mutual separating situation between/among the plurality of overhead wires and the positional deviation of each overhead wire.

4. The measuring apparatus as claimed in claim 2, wherein the processing device corrects the measurement signal outputted from the light receiving unit according to information indicative of a nonlinear characteristic of the measurement signal regarding each light receiving unit such that the corrected measurement signal is used to detect the mutual separating situation between/among the plurality of overhead wires and the positional deviation of each overhead wire.

5. A measuring method that measures mutual separating situation of overhead wires, comprising:
projecting, from a light projecting unit provided on a railway vehicle running on a railway, a measuring light spread in a strip shape in a width direction of the railway toward a plurality of overhead wires installed above the railway;
providing a plurality of light receiving units on the railway vehicle in a manner that each light receiving unit is separate to each other in the width direction of the railway, wherein each of the light receiving units is disposed to partially overlap a measurement area of each other such that all of the plurality of overhead wires within a predetermined measurement area fall within the measurement area of at least one of the light receiving units;
respectively receiving, by the plurality of light receiving units, a reflecting light which is reflected by all or a portion of the plurality of overhead wires from the measure light so as to output a measurement signal indicative of a contour of overhead wires; and
processing the measurement signal outputted from each light receiving unit according to installing position of each light receiving units to detect a mutual separating situation of the plurality of overhead wires and a positional deviation of each overhead wire.

6. The measuring method as claimed in claim 5, further comprising processing the measurement signal outputted from each receiving unit to detect a mutual separating situation between one of the plurality of overhead wires and an insulator which supports another overhead wire.

7. The measuring method as claimed in claim 5, further comprising correcting the measurement signal outputted from the light receiving unit according to information indicative of a nonlinear characteristic of the measurement signal regarding each light receiving unit such that the corrected measurement signal is used to detect the mutual separating situation between/among the plurality of overhead wires and the positional deviation of each overhead wire.

8. The measuring method as claimed in claim 6, further comprising correcting the measurement signal outputted from the light receiving unit according to information indicative of a nonlinear characteristic of the measurement signal regarding each light receiving unit such that the corrected measurement signal is used to detect the mutual separating situation between/among the plurality of overhead wires and the positional deviation of each overhead wire.
